(19) United States
(12) Patent Application Publication
(10) Pub. No.: US 2013/0045878 A1
(43) Pub. Date: Feb. 21, 2013

(54) PROCESS FOR IDENTIFICATION OF PATHOGENS

(71) Applicants: Lee Ann McCue, Richland, WA (US); Bobbie-Jo M. Webb-Robertson, Kennewick, WA (US)

(72) Inventors: Lee Ann McCue, Richland, WA (US); Bobbie-Jo M. Webb-Robertson, Kennewick, WA (US)

(73) Assignee: BATTELLE MEMORIAL INSTITUTE, Richland, WA (US)

(21) Appl. No.: 13/485,643

(22) Filed: May 31, 2012

Related U.S. Application Data
(60) Provisional application No. 61/492,128, filed on Jun. 1, 2011.

(51) Int. Cl. C40B 30/02

(52) U.S. Cl. 506/8

(57) ABSTRACT

Processes are described that include computational tools for identification of unknown pathogenic organisms and other threat agents (e.g., rare variants) in samples. The processes can be conducted without specific a priori knowledge of the unknown. Identification may include fragmenting a genome from one or more candidate organisms and READs and/or CONTIGs segments for the unknown organism in silico to form fragments, and determining the statistical relevance of exact fragment matches between the sample fragments and the candidate fragments.

### CROSS REFERENCE TO RELATED APPLICATION

This Application claims priority from U.S. Provisional Application No. 61/492,128 entitled “Identification of Pathogenic Agents” filed 1 Jun., 2011 which reference is incorporated in its entirety herein.

### STATEMENT REGARDING RIGHTS TO INVENTION MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### FIELD OF THE INVENTION

The present invention relates generally to identification of unknown organisms. More particularly, the invention relates to a system and process for identifying unknown (unidentified) biothreat organisms including pathogens by comparing DNA fragments (fractions) from the unknown organisms with DNA fragments of known organisms and matching the DNA fragments to identify the unknown biothreat agent.

### BACKGROUND OF THE INVENTION

A major challenge to law enforcement and/or 1^{st} responder communities is correctly identifying unknown threat agents at biological crime scenes to identify the agents as engineered, emerging, or rare variants of potential biothreat agents. While many biological assays are available, without a priori knowledge of the target (i.e., the unknown agent), current assay techniques may not identify the unknown agent and determine if it is a biological threat. After the anthrax attacks in 2001, genome sequencing using traditional Sanger sequencing detected a rare variant in a submitted laboratory culture that matched cultures taken from crime scene samples. However, conventional Sanger sequencing is slow compared to high throughput, massively parallel sequencers (MPS) now available such as the Roche 454, Illumina Genome Analyzer II, and ABI SOLiD platforms. MPS technology allows researchers to investigate genetic differences between organisms newly sequenced by MPS and those currently available in pathogen libraries. MPS technology provides millions of short [35 to 400 base pairs (bp)] READS without requiring a priori knowledge of the full-length sequence to facilitate detection of unknowns, rare variants, as well as emerging and engineered strains of potential biothreat agents. However, sensitivity and specificity of MPS technology for detection of varied threat agents has not yet been determined and must be demonstrated so that researchers can determine at what level of sensitivity potential biothreat agents can be detected. Accordingly, there remains a need for new approaches and computational tools to identify unknown DNA and organisms in samples with sufficient specificity and sensitivity. The present invention addresses these needs.

### SUMMARY OF THE INVENTION

Methods are described that employ an MSP-based approach for identifying DNA in samples containing unknown or unidentified organisms including pathogens and other threat agents by providing computational tools (algorithms) that address known problems in the prior art. The computational tools (algorithms) can provide identification or confirm identification of unknown organisms and threat agents (e.g., rare variants) without specific a priori knowledge of the unknown in a sample. As such, the present approach can provide an alternative and potentially more specific means of identification of unknown(s). The method may include: (a) fragmenting one or more genome(s) or partial genome(s) from one or more candidate organisms and READs and/or CONTIGs segments for the unknown organism in silico to form DNA fragments for each of same; (b) determining number of fragment matches between the unknown sample organism fragments and the candidate organism(s) fragments; and (c) identifying the unknown organism based on the statistical relevance of the match count. Method steps (a), (b), and/or (c) may be performed with a computer. The method may also include assembling READs segments de novo for an unknown organism to form CONTIGs segments before fragmenting the CONTIGs segments. In some embodiments, READs segments may be of a sufficient base length that forming CONTIGs segments is not needed prior to fragmentation. In some embodiments, CONTIGs segments for the unknown organism may include one or more READs segments.

Sequence data for candidate genomes and partial genomes may be obtained from public and private databases such as those maintained by the National Center for Biotechnology Information (NCBI). READs segments data may be derived from known MPS sources and/or platforms. READs segments originate from random locations in a genome. READs segments data can be next-generation sequenced (NGS) READs data. In some embodiments, the READs segments for the unknown organism can include from about 30 DNA bases to about 400 DNA bases, but are not limited thereto. In some embodiments, READs segments may include more than 400 DNA bases. Thus, no limitations are intended.

In some embodiments, fragmenting may include fragmenting CONTIGs segments derived from the unknown organism and may also includes fragmenting one or more known genomes to generate fragments for each. In some embodiments, fragmenting may include fragmenting with a recognition site that is a 3-base segment or greater. In some embodiments, fragmenting yields fragments for the unknown of a size greater than or equal to about 20 nucleotide bases. In some embodiments, fragmenting can yield fragments for the unknown of a size less than equal to about 20 nucleotide bases. In some embodiments, fragmenting may include restricting fragments obtained to remove those of a size below a preselected size threshold common in all fractions of candidate genomes and unknowns. In some embodiments, the size threshold may be a length equal to or below about 3 nucleotide bases.

Determining the statistical relevance between the unknown sample organism fragments and candidate fragments may include assigning a match score defined by the ratio of the number of matches between the unknown fragments and the candidate genome fragments divided by the total number of candidate genome fragments. Assigning a match score can also include counting the number of matches between the unknown organism fragments and the candidate organism(s) fragments.

Identifying the unknown organism may include calculating a probability that assesses the likelihood that fragments from the unknown organism(s) are identical to fragments derived from the known organism(s) or that identify the fragments as being from a known organism(s). Identifying the unknown organism can also include assigning a match score to numbers of matches identified between the unknown organism fragments and candidate fragments. In some embodiments, the match score may not assess the correctness of the identity of the unknown organism.

In some embodiments, the determining includes assigning a posterior probability for one or more candidate or reference genomes given the observed fragments from the unknown sample. In some embodiments, the probability is a Bayesian-based probability that assesses the likelihood of the identity of the unknown organism. And, a match score may be assigned in concert with a Bayesian probability approach that employs whole candidate genomes or partial genomes to classify the unknown fragments.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. Various advantages and novel features of the present invention are described herein and will be readily apparent to those of ordinary skill in the art from the following detailed description. As will be realized, the invention is capable of modification in various respects without departing from the invention. Accordingly, the drawings and description of the preferred embodiments set forth hereafter are to be regarded as illustrative in nature, and not as restrictive.

### BRIEF DESCRIPTION OF THE DRAWINGS

FIG. 1 is an exemplary flow sheet for determining identity of an unknown organism in accordance with an embodiment of the present invention.

FIG. 2 illustrates the process of de novo assembly of “reads” segments to form CONTIGs segments for an unknown organism.

FIG. 3 illustrates the process of in silico fragmentation that forms fragments for candidate genomes of known organisms and CONTIGs fragments for an unknown organism and the subsequent matching process.

FIG. 4 illustrates a process for identifying an unknown organism using a candidate match score obtained from the matching process.

FIG. 5 is a schematic showing an exemplary Bayesian-based approach that assesses probability that an unknown is the same as a known genome, according to an embodiment of the present invention

FIG. 6 compares results from a Bayesian probability approach to matching with a simple probability approach for identification of an unknown organism.

### DETAILED DESCRIPTION

Methods are described for identifying unknown organisms. “Organism” as defined herein means any biological entity or life form that includes sequence-able DNA. Methods described herein are of particular relevance to the identification of unidentified DNA and/or or unknown organisms that may be of a concern as potential or real threat agents including, e.g., pathogens, bacteria, viruses, and combinations of these various agents. The following description includes a preferred best mode of one embodiment of the present invention. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims. Therefore the present description should be seen as illustrative and not limiting.

The MPS approach described herein may provide a more rapid and specific identification of an unknown than traditional PCR-based approaches. Aspects of the present invention address several basic questions that must be considered, including: the ability of computational tools to make a “correct” call as well as the limits of the instrumentation and/or computational techniques. Such questions can be addressed by comparing short sequences or READS segments from an unknown to known genome data to determine if the computational tools made the correct identification. Limits of MPS sensitivity and specificity for unknown identification can then be determined using mixtures of target and non-target DNA.

Tools described herein are platform-independent and can be applied to existing and multiple platforms known in the art including, e.g., Roche 454, Illumina Genome Analyzer II, and ABI SOLiD DNA sequence platforms and associated data. MPS sequencing technologies are a preferred source of DNA sequence information because they provide a very large number of individual sequence READs segments per sample (>3×10⁸) that improve the potential for identifying threat-specific sequences in complex environmental samples. In addition, approaches described herein also address questions related to the identification of a biological threat(s) in an unknown sample. In particular, rather than querying for specific organisms, the present invention makes general inquiries about the presence of a biological threat in an unknown sample.

### Flow Sheet for Identifying Unknown Organisms

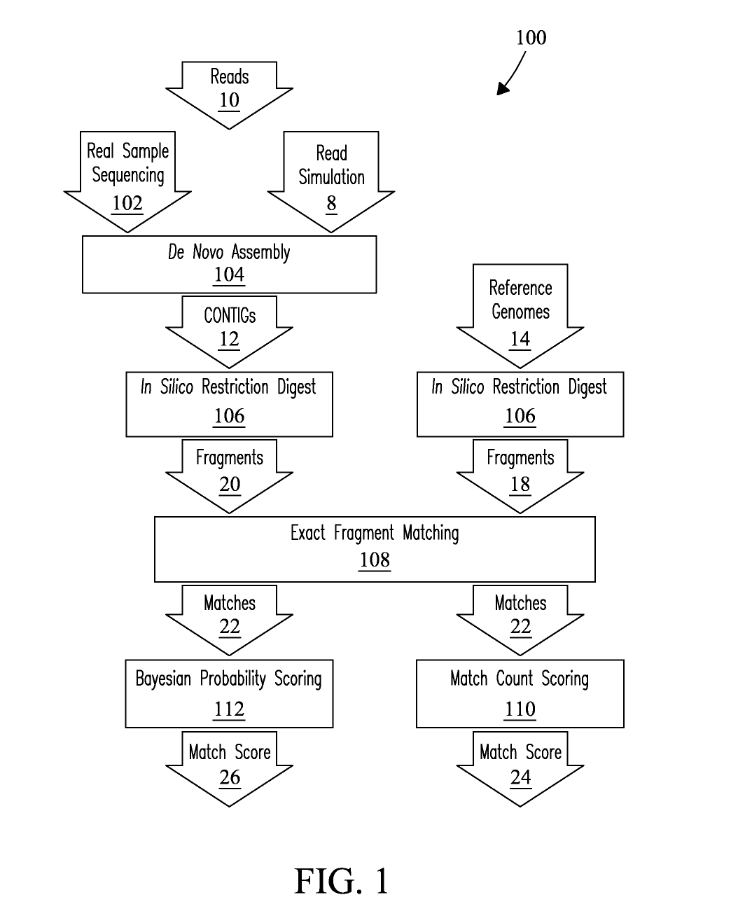

FIG. 1 shows an exemplary flow sheet 100 for identifying an unknown organism. {START} First (step 102), READS segments 10 for an unknown DNA or organism can be generated, e.g., by a next-generation sequencing (NGS) instrument or method that identifies bases and sequence data in the DNA. READS segments 10 may be derived from real sample sequence data or from simulated sequence data. “READ” and “READs” as these terms are used herein refer to segments or pieces of DNA that are read or sequenced by a sequencing instrument or another sequencing method. “CONTIG” and “CONTIGs” as these terms are used herein refer to a combination of two or more READ segments by any method. In another step (step 104), READS segments 10 may be assembled de novo to form CONTIGs segments 12. Assembly may be performed, e.g., with a de novo assembler or other de novo assembly process employing assembly software. Assembly may include locating overlapping sequences in individual READs segments and assembling the segments together. Assembly may provide assembly of a partial or complete genome. In another step (step 106), one or more candidate genomes 14 or partial genomes 14 from a known or reference organism may be fragmented in silico to form DNA fragments 18 for the candidate or reference genomes (partial or complete) 14, and READs segments 10 and/or CONTIGs segments 12 for the unknown organism may be fragmented in silico to form DNA fragments 20 for the unknown or sample organism 8. “Fragmentation” as the term is used herein means in silico fragmentation. Fragmentation 106 may involve fragmenting READs 10 and/or CONTIGs segments 12, and reference genomes 14 at locations where selected recognition sites 16 are located. For example, restriction enzyme (e.g., endonuclease) recognition sites may be used as locations at which to fragment the READs segments 10 and/or CONTIGs segments 12 and the candidate or reference genomes 14. Exemplary restriction enzymes with their respective recognition sites (in parentheses) include, but are not limited to, e.g., AluI (AGCT), DpnI (GATC), AcclI (CGCG) and MseI (TTAA). While four-nucleotide recognition sites 16 are described here, the approach is not limited thereto. For example, length of recognition sites 16 is not limited. For example, in some embodiments, recognition sites 16 will have a length of 4 bases or greater. In some embodiments, recognition sites 16 will have a length of 20 bases or lower. Thus, if shorter fragments 18 and 20 are desired, shorter recognition sites 16 may be used as they may appear more frequently in the READs segments 10 and/or CONTIGs segments 12 to be fragmented. If longer fragments 18 and 20 are desired, longer recognition sites 16 may be employed in the fragmentation of the READs segments 10 and/or CONTIGs segments 12. Thus, no limitations are intended. As an example, exemplary restriction enzymes that each recognize specific 4-nucleotide sequences were chosen based on a predicted frequency with which they would fragment CONTIGs segments 12. In a typical bacterial genome containing, e.g., 5×10⁶ nucleotides, recognition sites 16 each containing 4 nucleotides may be expected to have a predicted frequency in a given sequence of ˜[(¼)×10⁴] or about 1 in 256 nucleotides. Each recognition site 16 yields about 19,500 fragments for a typical bacterial genome. By applying four (4) different recognition sites 16, a sample pool of about 80,000 fragments may be obtained. The pool is sufficiently large (on average) to discriminate between sequences of different organisms, but not so large as to make exact matching too stringent. However, no limitation in the various lengths of recognition sites is intended. Recognition sites 16 may also be used in combination. In the exemplary process illustrated here, fragmentation may be performed with each recognition site 16 individually to generate four distinct sets of fragments for each DNA sequence analyzed. The four sets may then be combined to produce a fragment pool for each genome 14/CONTIG 12 set. Next (step 108), number of exact matches 22 may be determined by comparing fragments 20 from the unknown organism 8 and fragments 18 from the candidate or reference genomes (partial or complete) 14 from the known organisms 4. Next (step 110), the unknown organism 8 may be identified.

In some embodiments, identifying the unknown organism 8 may include assigning a match score 24 or 26 to matches 22 identified between the unknown organism fragments 20 and the candidate organism(s) fragments 18. In some embodiments, a match score 24 may be assigned that involves calculating 112 a simple ratio or percentage approach 112 based on the number of matches 22 identified between the unknown organism fragments 20 and the candidate organism(s) fragments 18 divided by the total number of fragments in the genome pool. In some embodiments, a match score 26 may be assigned based on a Bayesian probability or classification approach 114 detailed further herein.

In some embodiments, identifying the unknown organism 8 may include calculating a probability that assesses the likelihood that fragments from the unknown organism(s) are identical to fragments derived from the known organism(s), or that otherwise identify the fragments as being from a known organism(s). {END}.

### De Novo Assembly of READS Segments

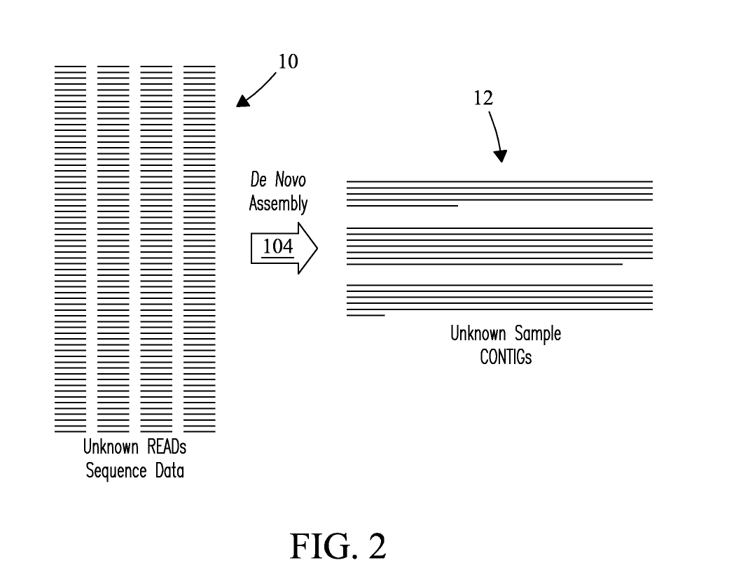

FIG. 2 illustrates an exemplary process for de novo assembly 104 of READs segments 10 from unknown organism 8 under examination to form CONTIGs segments 12. “De Novo” means the READs segments 10 are assembled in the absence of (i.e., without reference to) any known sequence information. “CONTIGsegments” 12 as the term is used herein means DNA segments of any length assembled from READs segments 10. De novo assembly 104 is illustrated using a set of four (4) exemplary READs segments 10 having the following sequences:

| | |
|---|---|
| READ [1]: | CGATGCATGTAGCGATCGGGCGATATCGAG |
| READ [2]: | CGATCGGGCGATATCGAGCGCTAGCGTTCG |
| READ [3]: | CGCTAGCGTTCGATTGCGATC(GCTAGTACC) |
| READ [4]: | (GCTAGTACC)AGGCTAGCTAGCAGACGCTAG |

Highlighted regions in each READs segment 10 contain overlapping sequences that appear in a subsequent READs segment 10. For example, READ [1] contains a segment “CGATCGGGCGATATCGAG” (underlined) that also appears in READ [2]. READ [2] contains a segment “CGCTAGCGTTCG” (bolded) that also appears in READ [3]. READ [3] contains a segment “GCTAGTACC” (underlined in parenthesis) that also appears in READ [4]. The assembly process looks for such overlaps and applies statistical constraints to combine the sequence into larger CONTIGs segments 12 that are as long as possible given available READs 10 data. Assembly of the four (4) READs 10 segments above can, for example, result in a single CONTIG segment 12 having the following sequence:

CGATGCATGTAGCGATCGGGCGATATCGAGCGCTAGCGTTCGATTGCGAT
C(GCTAGTACC)AGGCTAGCTAGCAGACGCTAG

Highlighted segments include overlapping sequences that may be used to assemble READs 10 segments into a resulting CONTIG segment 12. Since READs sequences 10 can originate from various random locations across a genome, some regions of a genome sequence may not be sufficiently covered. Therefore, an entire genome may not be fully connected into one sequence by applying one round of assembly. Additional assembly steps may be conducted. Thus, no limitations are intended. And, as will be further appreciated, the assembly process may be performed with sequencing software known in the sequencing arts.

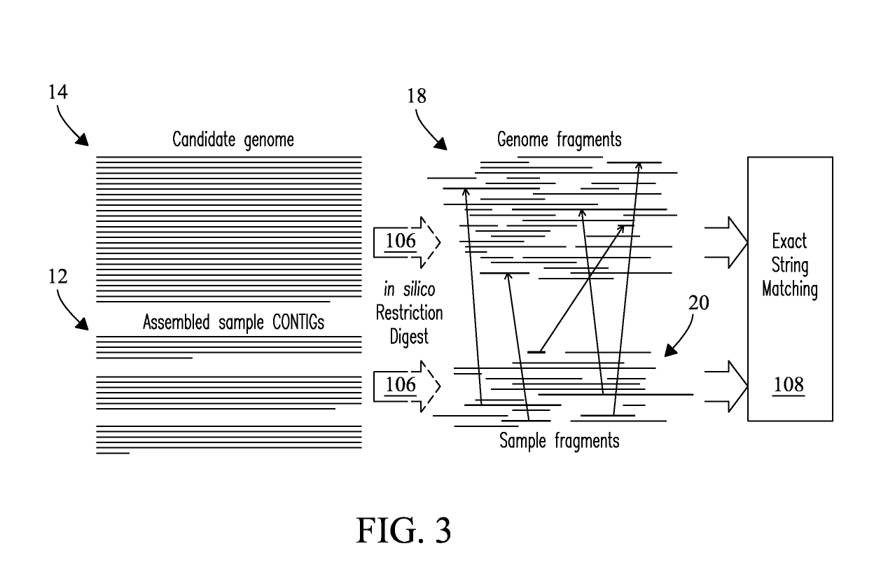

FIG. 3 illustrates the in silico fragmentation 106 process. CONTIGs segments 12 assembled from READS segments 10 obtained from unknown organism 8, and reference genomes 14 or partial genomes 14 for candidate organisms 4 (i.e., known DNA), may be fragmented 106 at locations where selected target sites 16 appear in both the candidate genome segments 14 and unknown CONTIGs segments 12 prior to fragmentation 106. Removal of small (≦20) nucleotide fragments that appear in the fragments 18 for the candidate genomes 14 and fragments 20 obtained from the CONTIGs segments 12 serves to retain fragments that contain useful or unique sequence information by which to identify unknown organism 8. For example, fragments containing fewer than about 20 base pairs are not typically useful for identifying unknown samples because 1) the fragments do not contain unique or structurally identifying sequence information by which to identify the unknown organism 8, or 2) may appear at such a frequency in multiples of organisms and genomes that can dilute and thus lower the probability scores important for determination of the unknown organism 8. Thus, small fragments may be purposely removed from the set of candidate fragments 18 and/or the set of unknown fragments 20 to improve the accuracy of the match (probability) score 22. For example, small fragments may be removed for the counting method described below, but may not be performed for the Bayesian probability scoring method. Instead, for the Bayesian probability scoring method described hereafter, fragments are inherently weighted based on their observed frequency across candidate genomes and in the final probability are therefore not useful in discriminating between samples. Once small or undifferentiating fragments are removed, candidate (i.e., known organism) genome fragments 18 and unknown fragments 20 derived from CONTIGs segments 12 may be compared and a number of matches determined.

### Match Count Approach

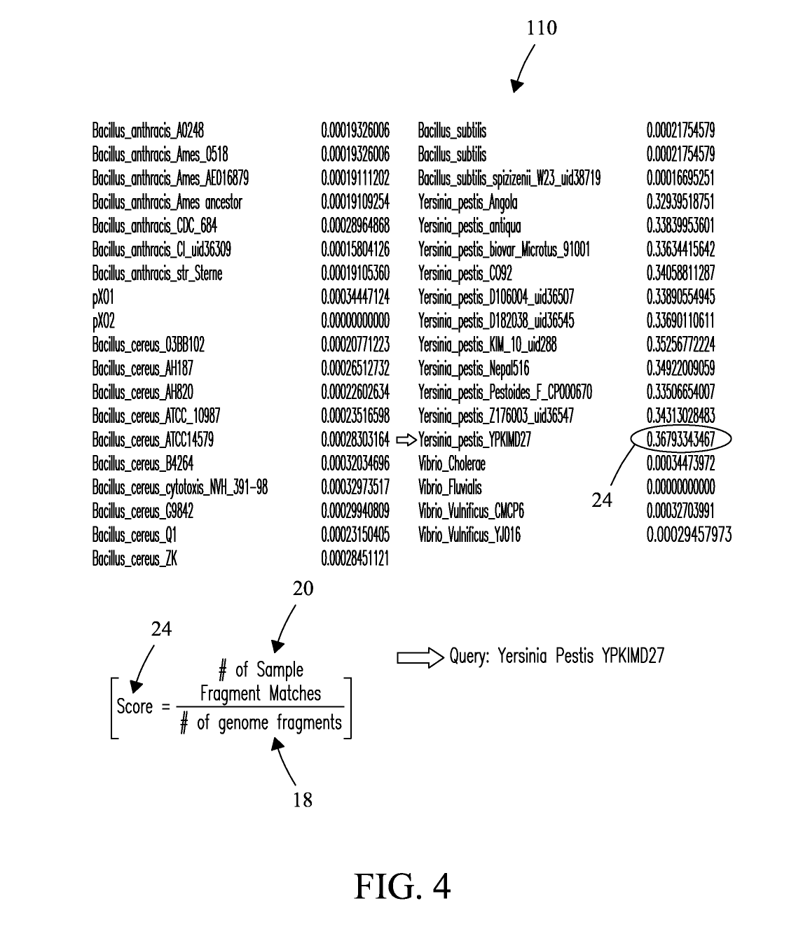

FIG. 4 illustrates a simple ratio, counting, or percentage approach 110 for scoring matching fragments to identify an unknown organism 8. Here, a match score 24 may be calculated by dividing the number of sample fragment 20 matches 22 (i.e., between the unknown fragments 20 and genome fragments 18) by the number of genome fragments 18 in a selected genome 14 (e.g., restricted or complete) to obtain a simple ratio or percentage, as given by Equation [1] below:

$$\begin{matrix}Match \\ Score\end{matrix} = \frac{[ Sample Fragment Matches to Genome ( X ) ]}{[ No . Fragments in Genome ( X ) ]} \qquad [ 1 ]$$

The scoring approach 110 counts number of matches 22 between a set of sample fragments 20 and a set of fragments from a candidate genome (X) 14 and divides the match count 22 by the number of fragments 18 in the selected candidate or reference genome (X) 14. Match scores 24 for any of a number of candidate genomes 14 may be likewise calculated and compared, e.g., by ranking match scores 24. Highest rank score 24 for a candidate genome (or a known relative to a known organism) may be taken as the identity of the unknown organism 8. In the figure, the match score 24 (i.e., 0.3679) identifies the unknown organism as Yersinia pestis.

### Bayesian Probability Approach

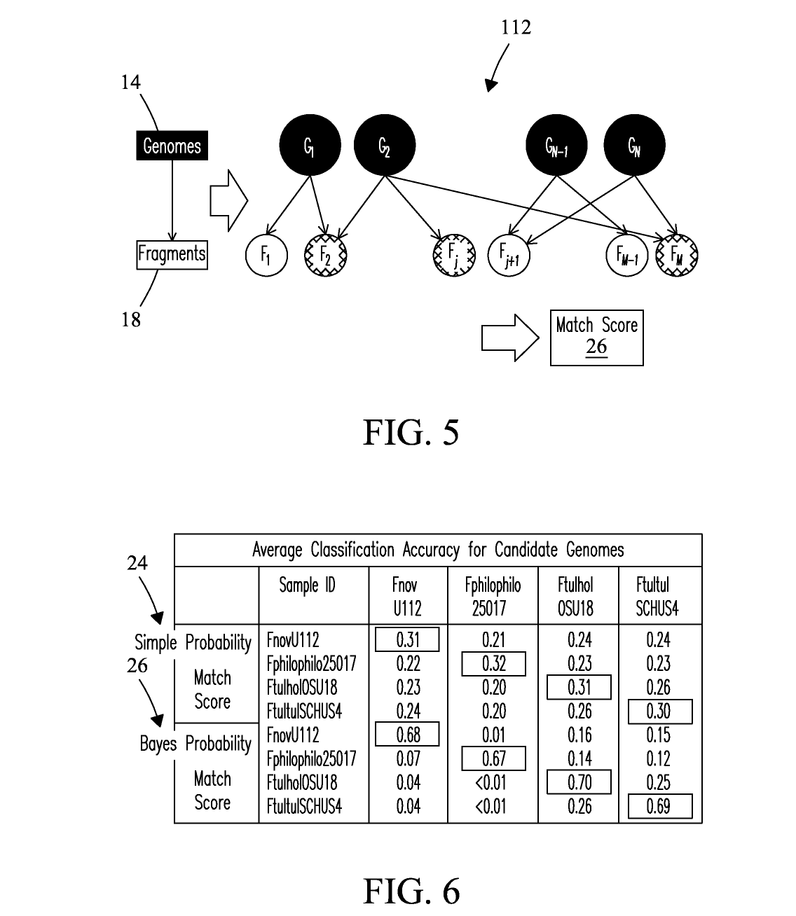

FIG. 5 shows a Bayesian approach 112 that assigns a probability to whether an unknown organism 8 is the same as a candidate (or reference) genome 14 of a known organism 4 or organisms 4. This approach 112 is based on the relationship between fragments 20 generated from the unknown organism 8 (e.g., threat agents or pathogens) and fragments 18 generated or obtained from candidate genomes (partial or complete) 14. The approach determines if any of the expected candidate fragments 18 are actually present or absent in the sample fragments 20. Equation [2] gives the overall statistical representation of the problem using Bayes formula:

$$P ( {G}_{i} \vert {F}_{1} , {F}_{2} , ⋯ , {F}_{j} , {F}_{j + 1} , . ⋯ , {F}_{M} ) = \frac{P ( {F}_{1} , {F}_{2} , ⋯ , {F}_{j} , {F}_{j + 1} , . ⋯ , {F}_{M} \vert {G}_{i} ) P ( {G}_{i} )}{{\sum }_{i = 1}^{N} P ( {F}_{1} , {F}_{2} , ⋯ , {F}_{j} , {F}_{j + 1} , . ⋯ , {F}_{M} \vert {G}_{i} ) P ( {G}_{i} )} \qquad [ 2 ]$$

Here, P(Gᵢ|F₁, F₂, . . . , Fⱼ, Fⱼ₊₁, . . . , F_{M}) represents the statistical probability (P) that any of the (M) fragments [(Fⱼ) where j=1 to M] from one of the (N) candidate genomes [(Gᵢ) where i=1 to N] appear in the set of fragments obtained from the sample containing the unknown DNA or unknown organism, or the probability that the known genome (Gᵢ) would have been seen given the fragments (Fⱼ) observed. As shown in the figure, each of the known genomes map to some number of fragments denoted by conditional arrows. Some fragments may overlap with many genomes, while others are unique. When a sample of interest is analyzed, fragments (Fⱼ) may be present **(gray)** or absent **(white)** as determined by the fragment (Fⱼ) data. A core benefit of this Bayesian approach is that it evaluates the likelihood of observing a fragment in the given state across all the known genomes. The simple counting approach described previously simply sums the number of arrows from each genome to a gray circle. Since fragments (Fⱼ) are expected to be independent due to cleavage rules, Equation [2] can be simplified to a product of probabilities that is easier to compute, as given by Equation [3]:

$$P ( {G}_{i} \vert {F}_{1} , {F}_{2} , ⋯ , {F}_{j} , {F}_{j + 1} , . ⋯ , {F}_{M} ) = \frac{P ( {G}_{i} ) {\prod }_{j = 1}^{M} P ( {F}_{j} \vert {G}_{i} )}{{\sum }_{i = 1}^{N} P ( {G}_{i} ) {\prod }_{j = 1}^{M} P ( {F}_{j} \vert {G}_{i} )} \qquad [ 3 ]$$

Here, each (Fⱼ) is an observed value: (0 if it is not observed in the data and 1 if it is). Thus, P(Fⱼ=1|Gᵢ) is the probability of observing (F₁) when genome (Gᵢ) is present. As shown in FIG. 5, if there is an arrow linking the genome (Gᵢ) and fragment (Fⱼ), then the fragment (Fⱼ) may be taken as an element (fragment) of (Gᵢ), and a high probability (e.g., 0.9) may be assigned to that fragment (Fⱼ). If not, a low probability (e.g., 0.1) may be assigned to that fragment (Fⱼ). Such values can also be trained into the algorithm. Since each incidence of a fragment (Fⱼ) is either present or absent (termed “Bernoulli”), Equation [3] may be re-written, as follows:

$$P ( {G}_{i} \vert {F}_{1} , {F}_{2} , ⋯ , {F}_{j} , {F}_{j + 1} , . ⋯ , {F}_{M} ) = \frac{P ( {G}_{i} ) {Π}_{j} {{P ( {F}_{j} = 1 \vert {G}_{i} )}^{{F}_{j}} [ 1 - P ( {F}_{j} = 1 \vert {G}_{i} ) ]}^{1 - {F}_{j}}}{{\sum }_{i = 1}^{N} P ( {G}_{i} ) {Π}_{j} {{P ( {F}_{j} = 1 \vert {G}_{i} )}^{{F}_{j}} [ 1 - P ( {F}_{j} = 1 \vert {G}_{i} ) ]}^{1 - {F}_{j}}} \qquad [ 4 ]$$

As will be recognized by those of ordinary skill in the art, product values (π) for M [i.e., a maximum number of fragments (Fⱼ)] can include millions to billions of fragments, which may not be easily computed. Thus, a small set of sample fragments containing, e.g., 20 fragments (Fⱼ) may be selected from the candidate genome pool or pools. This set may be chosen to provide, e.g., up to about 25% of known fragments (Fⱼ) in each potential genome (Gᵢ). The redacted size of these candidate genomes permits the algorithm to be rapidly repeated (e.g., up to 10,000 times) to attain an estimate of the total probability.

FIG. 6 compares match scores 26 for the Bayesian probability approach 112 to match scores 24 for the simple match count approach 110 described previously in reference to FIG. 4. In the figure, match scores 24 obtained from the simple match count approach 110 correctly identify unknown fragments 20 with a score of between about 0.30 to about 0.32 compared with scores for rejected fragments of between about 0.20 and 0.26. Match scores 24 identifying the correct fragments are about 25% ahead of the average score: [Fnov (U112): 0.31 compared with 0.22, 0.23, and 0.24], [Fphilophilo (25017): 0.32 compared with 0.20, 0.20, and 0.21], [Ftulhol (OSU18): 0.31 compared with 0.23, 0.24, and 0.26], and [Ftultul (SCHUS4): 0.30 compared with 0.23, 0.24, and 0.26]. Match scores 26 based on the Bayesian approach 112 also correctly identify unknown fragments 20. Here, match scores 26 are between about 0.68 and about 0.70 compared with scores for the rejected fragments of between about <0.01 and 0.26, or below about 0.19 on average. In the figure, match scores 26 positively identifying the unknown fragments 20 are about 370% (a factor of 3.7 times) ahead of the average (0.19) score: [Fnov (U112): 0.68 compared with 0.04, 0.04, and 0.07], [Fphilophilo (25017): 0.67 compared with <0.01, <0.01, and 0.01], [Ftulhol (OSU18): 0.70 compared with 0.14, 0.16, and 0.26], and [Ftultul (SCHUS4): 0.69 compared with 0.12, 0.15, and 0.25].

As will be appreciated by those of ordinary skill in the art, sensitivity and specificity of MPS computational tools can vary and their applicability may be conditional. Samples can first be generated and analyzed to assess the nature and sensitivity of MPS technology to detect a desired target and/or unknown. The following examples provide a further understanding of the present invention in one or more aspects.

### Example 1

### In Silico Restriction Digestion

Data sets from the de novo assembly described previously were used. Custom software was written to perform the in silico fragmentation described herein. For illustration purposes, a CONTIG segment 12 having the following sequence:

CGATGCATGTAGCGATCGGGCGATATCGAGCGCTAGCGTTCGATTGCGAT
CGCTAGTACCAGGCTAGCTAGCAGACGCTAG

As show here, a 4-base recognition site 16 (e.g., GATC) may be used to fragment the CONTIG segment 12, but the approach is not limited thereto as described previously herein. As the sequence of the CONTIG segment 12 is scanned, the sequence GATC 16 can be found at a first location starting at position (14) of the sequence, and at a second location starting at position (48), as shown hereafter:

| | |
|---|---|
| FRAGMENT [1]: | CGATGCATGTAGCGA |
| FRAGMENT [2]: | TCGGGCGATATCGAGCGCTAGCGTTCGAATTCGA |
| FRAGMENT [3]: | TCGCTAGTACCAGGCTAGCTAGCAGACGCTAG |

As shown, the GATC recognition site 16 fragments the CONTIG segment 12 between the bases at the recognition site 16 locations yielding three fragments 18. Fragmentation may then proceed at the “GATC” site for all CONTIGs 12 associated with a particular sample. If desired, another recognition site 16 (e.g., “AATT”) may also be applied to the original CONTIG 12 segment. When scanned, the “AATT” recognition site 16 may be found in the sequence, e.g., at position (43):

CGATGCATGTAGCGATCGGGCGATATCGAGCGCTAGCGTTCGAATTCGAT
CGCTAGTACCAGGCTAGCTAGCAGACGCTAG

Fragmentation may then proceed at the recognition site 16 location, e.g., between the bases of the recognition site 16. Two new fragments 18 may result, e.g., as follows:

| | |
|---|---|
| [1] | CGATGCATGTAGCGATCGGGCGATATCGAGCGCTAGCGTTCGAA |
| [2] | TTCGATCGCTAGTACCAGGCTAGCTAGCAGACGCTAG |

The entire genome 14 is fragmented for every recognition site 16 for all candidate genomes 14 used. As described herein, fragments 18 with a length below a selected threshold (e.g., 20 nucleotides) may be removed if desired. After all desired recognition sites 16 are applied, all resulting fragments may be pooled. The fragment pool may be considered to be representative of all DNA sequences in the unidentified sample and may be used in the subsequent matching step. The process may be repeated for all candidate or reference genomes employed 14 for comparison.

### Example 2

### Candidate Fragment Registry

A table or registry of candidate (reference) fragments 18 may be prepared by first scanning or entering candidate (reference) fragments 18 (e.g. ACCGATAGCT, GCTTAAGGC, and etc.) obtained from fragmentation (Example 1) for each candidate (known) genome 14 into the table or registry. “Fragments” as used here means distinct (i.e., unique) nucleotide sequences (i.e., not previously entered) of any length. Each new candidate fragment 18 in the candidate set may be compared to candidate fragments 18 already read or scanned into the table or registry. If a new fragment 18 currently being read or scanned in has not been previously entered, a new entry may be made or recorded indicating that the new fragment 18 is generated upon fragmentation of the selected genome 14. If a new fragment 18 currently being read or scanned in already has an entry in the table or registry under a selected genome 14, current fragment 18 may be disregarded as the entry for the current fragment 18 is already recorded for the current genome 14. The process continues until all candidate genome fragments 18 are scanned, read in, or otherwise entered into the table or registry. TABLE 1 shows an exemplary, completed fragment registry (simulated) showing fragment data for candidate (reference) 14 genomes useful for subsequent matching of unidentified (unknown) fragments 20 (Example 4). Here, three genomes are used. Here, the candidate (reference) genomes 14 each contain five (5) unique fragments 18. The candidate (reference) pool may be made up of all unique fragments 18 compiled or obtained from fragmentation (detailed in Example 1) of all candidate genomes 14.

TABLE 1
Simulated fragment data for candidate (reference) genomes.

| GENOME | | | |
|---|---|---|---|
| FRAGMENTS | ⁽²⁾CANDIDATE | ⁽²⁾CANDIDATE | ⁽²⁾CANDIDATE |
| POOL⁽¹⁾ | GENOME-1 | GENOME-2 | GENOME-3 |
| A | X | | |
| B | X | X | |
| C | | X | |
| D | X | X | |
| E | X | X | |
| F | | | X |
| G | | | X |
| H | X | | X |
| I | | X | X |
| J | | | X |

⁽¹⁾Candidate pool is the set of unique fragments obtained upon fragmentation of all candidate genomes combined.
⁽²⁾Fragment data listed for each candidate genome is the set of unique fragments obtained upon fragmentation of the selected genome only.

### Example 3

### Matching Unidentified Sample Fragments to Candidate Fragments

Number of exact matches between a set of sample (unknown) fragments 20 (Example 4) and candidate genome fragments 18 (Example 3) may be determined as follows. In an exemplary unknown (unidentified) sample, sample fragments A, B, E, and P 20 may be obtained or collected upon fragmentation (EXAMPLE 2) of the sample. Fragments 20 in the sample pool may then be matched as follows. Fragment-A (sample) 20 finds a single exact match with one candidate genome fragment 18 (i.e., Fragment-A of Genome 1) in TABLE 1. So, one count may be recorded for sample fragment-A 20 under Genome 1. Fragment-B (sample) 20 in the sample pool also finds a match with genome fragments 18 from both Genome-1 (candidate) 14 and Genome-2 (candidate) 14 in TABLE 1. Thus, one count may be recorded for the sample under each of Genome-1 and Genome-2. Next, Fragment-E (sample) 20 in the sample pool also finds a match with genome fragments 18 from both Genome-1 (candidate) 14 and Genome-2 (candidate) 14. Again, count values for Genome-1 and Genome-2 may each be incremented by one. Fragment P (sample) 20 does not find an exact match with any genome fragments 14, and count values for Genome-1, Genome-2, or Genome-3 are not incremented for Fragment P (sample) 20. This sample fragment 20 may be discarded. A table or registry or other counting means may be employed to record number of exact matches. The table or registry can provide a running total of the number of counts or matches obtained between sample fragments 20 when compared to candidate genome fragments 18. TABLE 2 lists count data obtained upon matching sample fragments 20 with the pool of candidate fragments 18 from TABLE 1.

TABLE 2
Match data between an exemplary sample fragment and candidate
(reference) genomes.

| SAMPLE | | | |
|---|---|---|---|
| FRAGMENTS⁽¹⁾ | ⁽²⁾GENOME-1 | ⁽²⁾GENOME-2 | ⁽²⁾GENOME-3 |
| A | X | — | — |
| B | X | X | — |
| E | X | X | — |
| P | — | — | — |
| TOTAL COUNT: | 3 | 2 | 0 |

⁽¹⁾Sample fragments derive from the set of unique fragments obtainable upon fragmentation of DNA obtained from an unknown or unidentified sample.
⁽²⁾Identifies exact matches between sample fragments (listed at left) that have an exact match with an identical fragment from the candidate genome.
TOTAL COUNT tabulates number of matches between sample fragments and candidate (reference) fragments for a given candidate genome.

With all fragments 20 in the sample pool scanned or entered, total fragment match counts for each candidate genome may be tabulated. In TABLE 2, three (3) sample fragments 20 (i.e., Fragment A, B, and E) find corresponding exact matches with candidate genome fragments 18 from Genome-1 of TABLE 1. Two (2) sample fragments 20 (i.e., Fragments B and E) find corresponding exact matches with genome fragments 18 from Genome-2. No sample fragments 20 find corresponding exact matches with genome fragments 18 from Genome-3. Scoring may proceed by two methods detailed hereafter.

### Example 4

### Match Count Scoring

Example 4 details a match scoring approach based on number of match counts, a match ratio, or a match percentage between sample fragments 20 and candidate (reference) fragments 18. A ratio score may be defined by the number of sample fragment 20 matches divided by the number of candidate fragments 18 in the candidate genome. In TABLE 2, three (3) sample fragments 20 match with candidate fragments 18 from TABLE 1 in Genome-1. Two (2) sample fragments 20 match with candidate fragments 18 in Genome-2. No (0) sample fragments 20 match with candidate fragments 18 in Genome-3. Ratio scores for the sample fragments are 0.6 [i.e., 3 sample fragment 20 matches 22 divided by 5 candidate fragments 18 in Genome-1], 0.4 [2 sample fragment 20 matches 22 divided by 5 candidate fragments 18 in Genome-2], and 0 [0 sample fragment 20 matches 22 divided by 5 candidate fragments 18 in Genome-3], respectively. Here, the unknown sample is identified as having the profile of Genome-1 based on Genome-1 having the highest match score 24.

### Example 5

### Bayesian Scoring

The Bayesian score can be computed directly from TABLE 1 and TABLE 2 using Equation [4]. For demonstration purposes, a value for P(Fⱼ=1|Gᵢ=0.9] may be set. However this value can be set, e.g., based on user information collected from sequencing technology, or can be trained using example data. In the latter case, values may be different for each fragment and genome. For Genome-1, from TABLE 1 and Equation [2], the left side of the equation may be defined as follows:

P(G₁|A=1,B=1,C=0,D=0,E=1,F=0,G=0,H=0,I=0,J=0)

The numerator may then be defined based on conditions for each fragment, as follows:

⅓([(0.9)^{A}(1−0.9)^{1-A}]*[(0.9)^{B}(1−0.9)^{1-B}]* . . . * [(0.9)^{J}(1−0.9)^{1-J}])

Here, (⅓) is presumed because each of the three genomes may be considered equally likely a priori. There are 10 candidate fragments 18 for Genome-1. Since the sample fragments 20 match three of the candidate fragments 18, the equation numerator for Genome-1 becomes:

⅓([(0.9)³(0.1)⁷])=7.3e−8. Genome-1:

Following the same formulation, Genome-2 and Genome-3 have the following values in the numerator, respectively:

⅓([(0.9)²(0.1)⁸])=8.1e−9. Genome-2:

⅓([(0.1)¹⁰])=1.0e−10. Genome-3:.

Applying Bayes rule, a final posterior probability for each genome is obtained given the possible fragments:

$$P ( {G}_{1} \vert GenomeFrags ) = \frac{7.3 e - 8}{7.3 e - 8 + 8.1 e - 9 + 1.0 e - 10} = 0.899$$

$$P ( {G}_{2} \vert GenomeFrags ) = \frac{8.1 e - 9}{7.3 e - 8 + 8.1 e - 9 + 1.0 e - 10} = 0.100$$

$$P ( {G}_{3} \vert GenomeFrags ) = \frac{1.0 e - 10}{7.3 e - 8 + 8.1 e - 9 + 1.0 e - 10} = 0.001$$

The unknown sample may then be identified as having the profile of Genome-1 given that Genome-1 has the highest posterior probability.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

1. A method for identifying an unknown organism, comprising the steps of:
(a) fragmenting one or more genome(s) from a candidate organism(s) and READs and/or CONTIGs segments for the unknown organism in silico to form DNA fragments for each of same; and
(b) determining number of fragment matches between the unknown sample organism fragments and the candidate organism(s) fragments; and
(c) identifying the unknown organism based on the match count.

2. The method of claim 1, wherein steps (a), (b), and/or (c) are performed with a computer.

3. The method of claim 1, further including assembling READs segments de novo for an unknown organism to form CONTIGs segments for same prior to fragmenting.

4. The method of claim 1, wherein the READs segments for the unknown organism are next-generation sequenced (NGS) READs.

5. The method of claim 1, wherein the CONTIGs segments for the unknown organism include one or more READs segments.

6. The method of claim 1, wherein the fragmenting includes fragmenting CONTIGs segments derived from the unknown organism and one or more known genomes to generate fragments for each.

7. The method of claim 1, wherein the fragmenting includes a recognition site that is a 3-base segment or greater.

8. The method of claim 1, where the fragmenting yields fragments for the unknown of a size greater than or equal to about 20 nucleotide bases.

9. The method of claim 1, where the fragmenting yields fragments for the unknown of a size less than or equal to about 20 nucleotide bases.

10. The method of claim 1, wherein the fragmenting includes restricting fragments obtained to remove those of a size below a preselected size threshold common in all fractions of all candidate genomes and the unknowns.

11. The method of claim 10, wherein the size threshold is a length below about 3 nucleotide bases.

12. The method of claim 1, wherein the determining includes assigning a match score defined by the ratio of the number of matches between the unknown fragments and the candidate genome fragments divided by the total number of candidate genome fragments.

13. The method of claim 12, wherein the match score does not assess correctness of the identity of the unknown organism.

14. The method of claim 1, wherein the determining includes assigning a posterior probability for one or more candidate or reference genomes given the observed fragments from the unknown sample.

15. The method of claim 14, wherein the probability is a Bayesian-based probability that assesses the likelihood of the identity of the unknown organism.

16. The method of claim 1, wherein the unknown organism is a threat agent selected from the group consisting of: a pathogen, a bacterium, a virus, and combinations thereof.


SEQUENCE LISTING (12 sequences)

SEQ ID NO: 1 - DNA, 30 bp, Artificial Sequence
  Exemplary sequence to illustrate invention
cgatgcatgtagcgatcgggcgatatcgag

SEQ ID NO: 2 - DNA, 30 bp, Artificial Sequence
  Exemplary sequence to illustrate invention
cgatcgggcgatatcgagcgctagcgttcg

SEQ ID NO: 3 - DNA, 30 bp, Artificial Sequence
  Exemplary sequence to illustrate invention
cgctagcgttcgattgcgatcgctagtacc

SEQ ID NO: 4 - DNA, 30 bp, Artificial Sequence
  Exemplary sequence to illustrate invention
gctagtaccaggctagctagcagacgctag

SEQ ID NO: 5 - DNA, 18 bp, Artificial Sequence
  Exemplary sequence to illustrate invention
cgatcgggcgatatcgag

SEQ ID NO: 6 - DNA, 12 bp, Artificial Sequence
  Exemplary sequence to illustrate invention
cgctagcgttcg

SEQ ID NO: 7 - DNA, 81 bp, Artificial Sequence
  Exemplary sequence to illustrate invention
cgatgcatgtagcgatcgggcgatatcgagcgctagcgttcgattgcgatcgctagtaccaggctagctagcagacgctag

SEQ ID NO: 8 - DNA, 15 bp, Artificial Sequence
  Exemplary sequence to illustrate invention
cgatgcatgtagcga

SEQ ID NO: 9 - DNA, 34 bp, Artificial Sequence
  Exemplary sequence to illustrate invention
tcgggcgatatcgagcgctagcgttcgaattcga

SEQ ID NO: 10 - DNA, 32 bp, Artificial Sequence
  Exemplary sequence to illustrate invention
tcgctagtaccaggctagctagcagacgctag

SEQ ID NO: 11 - DNA, 44 bp, Artificial Sequence
  Exemplary sequence to illustrate invention
cgatgcatgtagcgatcgggcgatatcgagcgctagcgttcgaa

SEQ ID NO: 12 - DNA, 37 bp, Artificial Sequence
  Exemplary sequence to illustrate invention
ttcgatcgctagtaccaggctagctagcagacgctag